(19) United States
(12) Patent Application Publication
(10) Pub. No.: US 2017/0144133 A1
(43) Pub. Date: May 25, 2017

(54) METHOD FOR MAKING A CATALYST METAL SUBSTRATE FOR GROWTH OF CARBON NANOTUBES

(71) Applicant: General Nano LLC, Cincinnati, OH (US)

(72) Inventor: Jae KIM, Mason, OH (US)

(21) Appl. No.: 15/323,594

(22) PCT Filed: Jul. 1, 2015
(86) PCT No.: PCT/US2015/038809

§ 371 Date: Jan. 3, 2017

Related U.S. Application Data
(60) Provisional application No. 62/020,081, filed on Jul. 2, 2014.
(60) Provisional application No. 62/150,459, filed on Apr. 21, 2015.

(51) Int. Cl. B01J 21/04; B01J 35/04; B01J 37/02; B01J 23/83

(52) U.S. Cl. CPC B01J 21/04; B01J 23/83; B01J 35/04; B01J 37/0215; B01J 37/0225; B01J 37/0244; C01B 31/0233

(57) ABSTRACT

A wet chemical process for forming a catalyst metal substrate for growing carbon nanotubes. The process deposits an alumina sol layer comprising oxyhydroxide molecules, which are annealed to form a stable alumina sol layer on the substrate. A further step deposits CNT catalyst metals onto the alumina sol layer substrate to form a catalyst metal-oxide, on which CNT arrays are grown. A further step hydrates the catalyst metal substrate for a time sufficient to improve CNT growth. The process enables roll-to-roll manufacturing of high quality CNT arrays.

### FIELD OF THE INVENTION

The present invention relates generally to preparation of an alumina support layer for deposition of a growth catalyst, and the growing of carbon nanotube arrays on the alumina catalyst growth substrate.

### BACKGROUND OF THE INVENTION

Carbon nanotubes (CNTs) have excellent electrical and thermal properties along with mechanical properties. This has intensively inspired academic and industrial research on their growth and potential applications including a conductor, thermal interface materials, electromagnetic shields, multifunctional composites, and electrodes in energy storage and conversion devices. As a result of these efforts, CNTs have taken firm hold as an essential center in the field of nanomaterials and nanotechnology for several decades.

Significant research has been done to understanding of the growth mechanism of CNTs and considerable efforts for developing high throughput and reliable CNT production using cost-effective manufacturing processes. On one hand, a large amount of CNT production has been made in forms of powder, sheets, or arrays in industry prevalently by floating catalyst CVD methods in which solid catalysts like ferrocene are injected into a chamber by organic solvents. The CNTs can be typically applied to CNT composites as an additive to enhance the properties of matrix materials, even though the as-produced CNTs are more or less contaminated with catalyst metals that can degrade or introduce unwanted effects and properties in the final products.

Production of CNTs can be fairly well produced by substrate-bound CVD methods, i.e. CNT arrays are grown on catalysts which have been coated on substrates by physical vapor deposition such as e-beam or sputtering evaporation. The arrays are highly pure, vertically aligned, and able to control their density and length so that they may have wider applications with high performance. Unfortunately, such methods have significant obstacles to produce the CNT arrays on a large area and in high volume because of the need for vacuum deposition equipment for depositing CNT catalysts. Although the equipment is mature in the semiconductor industry, it is relatively expensive and not suitable for large-scale continuous processes due to its limited chamber size and relatively longer processing cycles.

It is thus desirable to explore alternative methods for depositing catalysts continuously in order to produce highly pure and controllable CNT arrays in high volume and on large area. This significantly impacts the success of CNT-based applications and commercialization.

Considerable efforts have been made to coat CNT catalysts continuously by introducing wet chemical processes in which CNT catalysts can be dispersed on various substrates. These include spin-coating, spray-coating and dip-coating methods. The spin-coating is not readily scalable to continuous-feed processing, but confines substrates to spin-allowable sizes even though it has been routinely used in semiconductor industry. The spray-coating processes are well known, but control of the film thickness at high coating rates can be a problem. Dip-coating can be a simple, cost-effective, and scalable process for coating CNT catalysts continuously and uniformly on various substrates. The dip-coating process has been studied to control both the diameter and chirality of CNTs at an earlier stage by coating as-synthesized nanoparticles. The process has recently attracted much interest as an alternative to physical vapor deposition methods for scalable production of CNTs. However, the nanoparticles are prepared by complicated synthetic routes, separated by tedious procedures to select a proper particle size, or coated by macromolecule-assisted dispersion. This may not be suitable for cost-effective and scalable production of CNTs.

Examples of wet chemical process for applying a catalyst metal to a CNT growth substrate include U.S. Pat. Nos. 8,487,028, 8,278,380, 7,604,839, 7,365,118, 6,589,457, all hereby incorporated by reference.

Therefore there remains a need for a facile, fast, cost-effective, and scalable wet chemical process to coat CNT catalysts on various large substrates or large surface-to-volume ratio substrates.

### SUMMARY OF THE INVENTION

There has been particular success in growing CNT arrays on substrates having an alumina layer that supports the catalyst metal. Such CNT arrays generally do not grow well without alumina films on which the CNT catalyst metals are placed.

An aspect of the present invention is a substrate having an alumina support layer comprising an outer surface comprising aluminum oxyhydroxide moieties, as a support and complexing site for a catalyst metal.

A further aspect of the present invention is a substrate having a very-thin-film coating (greater than about 10 nanometers, and up to about 100 nanometers, or more, in thickness) of an alumina support layer comprising aluminum oxyhydroxide, as a support and complexing site for a catalyst metal.

Another aspect of the invention is a substrate, including an elongated planar substrate, including a roll substrate, having an alumina support layer comprising aluminum oxyhydroxide.

A further aspect of the invention is a substrate, including an elongated planar substrate, having an alumina support layer comprising an outer surface comprising aluminum oxyhydroxide moieties and an auxiliary metal oxyhydroxide.

Another aspect of the present invention provides a method for making the alumina layered substrate, including an elongated planar alumina layered substrate, by a wet chemical processing method that includes applying a solution comprising aluminum alkoxides, aluminum oxyhydroxides, or a mixture thereof, onto a surface of a substrate.

Another aspect of the invention is the application of the solution or sol solution onto the substrate using spraying, dip coating, roll coating, curtain coating, slot coating, slide coating, and spin coating, including in a roll-to-roll process. Fluidized bed coating is also a useful process for coating particulate substrates.

The present invention provides a method for applying an alumina catalyst support layer onto a substrate, comprising the steps of: applying a coating of an alumina solution comprising aluminum oxyhydroxide and a solvent onto a substrate, and annealing the coating of the alumina solution on the substrate, to remove the solvent, and to form an annealed alumina catalyst support layer comprising aluminum oxyhydroxide.

The present invention further provides a method for applying an alumina catalyst support layer onto a continuous sheet substrate, comprising the steps of: providing an alumina solution comprising aluminum oxyhydroxide and a solvent; moving continuously a sheet substrate through the alumina solution to apply a coating onto the sheet substrate, and annealing the coating of the alumina solution on the sheet substrate, to remove the solvent, and to form an annealed alumina catalyst support layer comprising aluminum oxyhydroxide.

A further aspect of the present invention is a catalyst metal-coated substrate that comprises a complex of a catalyst metal with the aluminum oxyhydroxide of the alumina support layer.

A further aspect of the invention is a catalyst metal-coated substrate having an alumina support layer comprising a complex of a catalyst metal and an auxiliary metal with the aluminum oxyhydroxide of the alumina support layer.

Another aspect of the present invention provides a method for making the catalyst metal-coated substrate, by a wet chemical processing method that includes applying a stabilized catalyst metal solution onto the aluminum oxyhydroxide of the alumina catalyst support layer of a substrate.

The present invention also provides a process for applying a catalyst metal on an alumina catalyst support layer of a substrate, including a continuous roll sheet substrate, comprising the steps of: a) applying a coating of a catalyst metal solution comprising a catalyst metal and a metal ligand, onto the annealed alumina support layer of the substrate, the annealed alumina support layer comprising aluminum oxyhydroxide; and b) annealing the coating of the catalyst metal solution on the annealed alumina catalyst support layer of the substrate, to form a catalyst metal oxide with the aluminum oxyhydroxide of the annealed alumina support layer.

The present invention further provides a process for applying a catalyst metal on an alumina catalyst support layer of a continuous sheet substrate, including a roll substrate, comprising the steps of: a) providing a catalyst metal solution comprising a catalyst metal complex and a metal ligand, b) providing a sheet substrate comprising the alumina support layer, the alumina support layer comprising aluminum oxyhydroxide, c) moving continuously the sheet substrate through the catalyst metal solution, to apply a coating of the catalyst metal solution onto the sheet substrate; and d) annealing the coating of the catalyst metal solution on the alumina catalyst support layer of the substrate, to form a catalyst metal oxide with the aluminum oxyhydroxide of the alumina support layer.

A further aspect of the present invention is a catalyst metal growth substrate comprising an alumina surface, and a catalyst metal, useful for making carbon nanotubes (CNTs) in a CNT growth furnace, made by the wet chemical process described herein.

Another aspect of the present invention provides a method for improving the growth of CNTs grown on a catalyst metal-coated substrate including the step of hydrating the catalyst metal coating of the catalyst metal-coated substrate, and annealing the resulting catalyst metal-coated substrate. The hydrated and annealed catalyst metal-coated substrate improves the consistency of the length of growth of the CNTs upon the substrate.

### BRIEF SUMMARY OF THE FIGURES

FIG. 1 shows a schematic of a wet process for applying alumina sol coating on a sheet substrate.

FIG. 2 shows an effect of the thickness of an e-beam evaporated alumina layer on the growth length of CNT arrays.

FIGS. 3A-3E show the surface morphology of an alumina sol film with a withdrawing speed of the stainless steel sheet from the sol solution of 0.1M aluminum oxyhydroxide, where:

FIG. 3A shows the stainless steel only;

FIG. 3B shows the as-coated alumina sol on the sheet, after annealing, at a withdrawing speed of 2 inches per minute;

FIG. 3C shows the as-coated alumina sol on the sheet, after annealing, at a withdrawing speed of 4 inches per minute;

FIG. 3D shows the as-coated alumina sol on the sheet, after annealing, at a withdrawing speed of 8 inches per minute; and

FIG. 3E shows a magnified view of the portion “E” of FIG. 3D.

FIG. 4 shows the effect of the thermal annealing treatment of the thinner alumina sol (0.1M aluminum oxyhydroxide) layer on the substrate, on the growth height of the CNT array.

FIG. 5 shows the effects of A) Delay Time 1 and B) Delay Time 2 on the growth height of the resulting grown CNT arrays.

FIG. 6 shows a schematic diagram of the process system and steps for depositing and annealing an alumina sol layer and then depositing and annealing a catalyst metal layer onto a sheet substrate.

FIG. 7 shows: A), an SEM image of a CNT array grown on a metal catalyst substrate of the present invention; B), an SEM image of a grown CNT array grown on a substrate on which the metal catalysts were deposited by e-beam; and C), a graph showing the I_{G}/I_{D} Raman ratios of the CNTs grown on a metal catalyst substrate of the present invention (“liq. cat.”) and of the CNTs grown on the substrate with e-beam-deposited metal catalysts (“e-beam”).

FIG. 8 shows sub-millimeter-long CNTs grown on the surface of beads: A) an alumina bead; B) a stainless steel bead; and C) a ceramic bead.

FIGS. 9A and 9B show a method for coating a sol solution onto a particulate substrate.

FIG. 10 shows a schematic diagram of the process system and steps for hydrating the CNT catalyst metal substrate.

FIG. 11 shows a change of alumina composition in the surface volume in the course of hydrating the CNT catalyst metal substrate: FIG. 11a, unwashed catalyst metal substrate, FIG. 11b, washed and cured catalyst metal substrate, and FIG. 11c, substrate by conventional electron beam deposition of alumina according to the prior art.

FIG. 12 illustrates the improvement of a water immersion on the consistency of CNT growth for a series of metal catalysts substrate samples when using alumina sol solution of pH 9.4.

FIGS. 13A and 13B show the effects of the thermal annealing treatment and thickness (withdrawing speed) of a layer of thicker alumina sol (0.13M aluminum oxyhydroxide of pH 4.65) on the substrate, upon the growth height of the CNT array.

### DETAILED DESCRIPTION OF THE INVENTION

The wet chemical process of the present invention enables a fast and scalable continuous process for depositing both alumina sol layers and CNT catalyst metals onto a rolled-sheet substrate, resulting in roll-to-roll manufacturing of high quality CNT arrays.

### A. Depositing Aluminum Oxyhydroxide

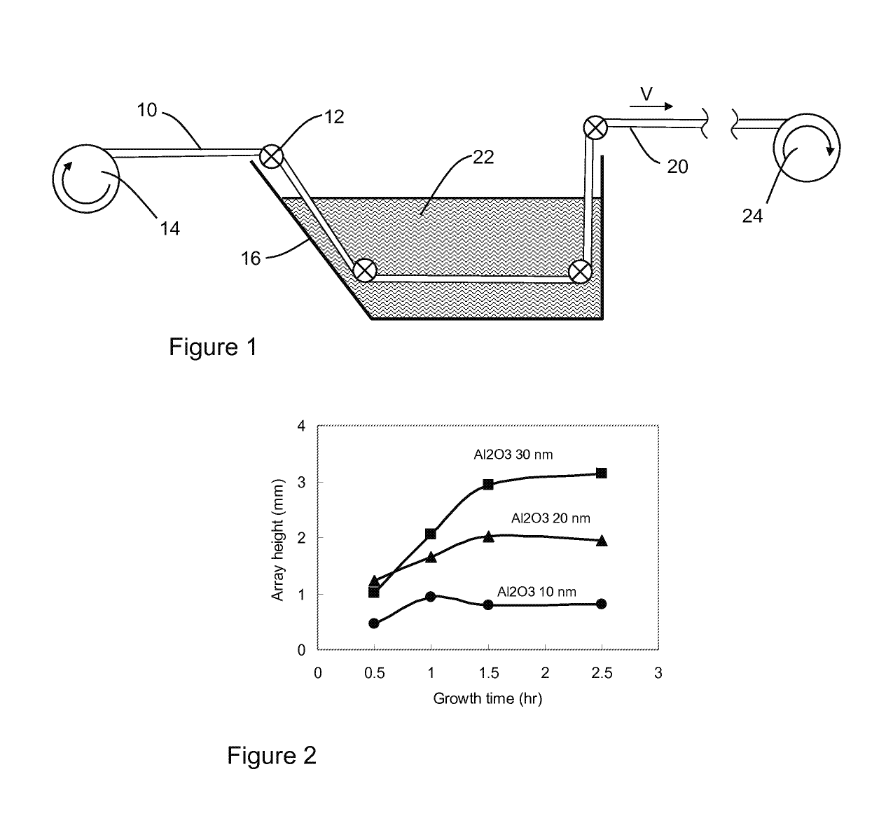

FIG. 1 shows a system for applying a coating of an alumina solution comprising aluminum oxyhydroxide and a solvent onto a continuous sheet substrate 10. The continuous sheet substrate 10 can be unrolled from a supply roll 14 of sheet substrate, and guided with a plurality of guide rollers 12 through a tank 16 containing the alumina sol solution 22. The guide rollers 12 guide the sheet down into, and up vertically out of, the solution 22 at a linear speed, V, to form an alumina sol-coated sheet substrate 20. The speed (velocity) V is usually controlled by a take-up roller 24 (optional) at a distal end of the process.

An aluminum oxyhydroxide (AlOₓ(OH)_{y}, where y=3−2x; for example, AlO(OH) and AlO_{1/2}(OH)₂) coating is applied onto a surface of a substrate. A non-limiting example of a method of applying a coating includes dipping a substrate into, and withdrawing it from, an alumina sol solution comprising an alumina precursor selected from the group consisting of aluminum oxyhydroxide, aluminum alkoxide, and mixtures thereof. Sol solutions comprising aluminum oxyhydroxide can further comprise an organic ligand that enhances the stability (reduces polymerization) of the aluminum oxyhydroxide in the sol solution, and prevents the formation of large alumina polymer precipitates. Aluminum alkoxides contained in a sol solution that also contains water will hydrolyze to aluminum oxyhydroxide.

The aluminum alkoxide has the chemical formula: Al(OR)₃, wherein R comprises an alkyl group, branched alkyl group, or aryl group having between 2 and 6 carbon atoms. Exemplary of suitable aluminum alkoxides which may be used in this invention include, but are not limited to, ethoxides, (n-, or iso) propoxides, (n, sec, or tert-) butoxides, or (n, sec, or tert) amyloxides such as tris(2-propoxide), tris(2-amyloxide), tris(tert-butoxide), and tris(sec-butoxide), with the latter butoxide being preferred. Compatible mixtures of such alkoxides can also be employed. U.S. Pat. Nos. 5,134,107, 5,210,062 and 5,403,807 describe sol compositions and their methods for making, the disclosures of which are incorporated by reference in their entireties.

The sol solution also includes a solvent, and typically a polar solvent that improves the solubilizing and homogeneity of the aluminum alkoxide and/or aluminum oxyhydroxide, reduces solution viscosity, and improves the wettability (that is, reduces the contact angle of the sol solution with a selected substrate). Non-limiting examples of a solvent include a C₁-C₈ linear or branch-chained alcohol, including the alcohol of the aluminum alkoxide used, dimethylformamide, and dimethylsulfoxide, and mixtures thereof.

The sol solution also further includes an organic ligand for enhanced stability of the aluminum oxyhydroxide and for preventing the formation of large alumina polymer precipitates. Non-limiting examples of the organic ligand include alkyl acetoacetate and acetylacetone where alkyl represents a linear or branched alkyl group having 1 to 6 carbon atoms, and the combination thereof.

The sol solution can comprise a molar ratio of aluminum alkoxide to organic ligand of about 0.1 to 4, including about 0.25 to 1, and more typically about 0.3 to about 0.7.

The alumina solution can include a solution made by combining aluminum (C₂-C₆) alkoxide, an organic ligand, and a polar solvent.

Method 1. Synthetic Method of Aluminum Oxyhydroxide Solution: Diluting Method.

The alumina sol solution can be prepared by mixing in the organic ligand, for example, ethyl acetoacetate (EtAcAc), with a solvent, for example, isopropyl alcohol (“IPA”). The aluminum alkoxide source material, for example, aluminum tris(sec-butoxide) (“ASB”)) is then stirred into the EtAcAc solvent solution. The volume of the solvent in the resulting procedure can be increased by adding additional solvent for adjusting or improving the homogeneity, solubility or viscosity of the sol solution. Once the sol solution has been thoroughly stirred (for example, up to 2 hours, or more), a volume of water (deionized) can be added into the sol solution to dilute the solvent. The addition of water to the sol solution also hydrolyzes the aluminum alkoxides to aluminum oxyhydroxide. After such a period of time, the solution comprising essentially only the aluminum oxyhydroxide, with nil aluminum alkoxide, can be further diluted with solvent.

A typical molar concentration in the resulting sol solution is about 0.05-0.5 M, including about 0.05-0.3 M, and about 0.1-0.16 M, aluminum oxyhydroxide sol solution, (based on the alkoxide precursor), more typically about 0.13 M. Higher levels of aluminum oxyhydroxide may result in a thicker, more viscous solution, a thicker coating, and a more rapid polymerization of the alumina. The pH of the resulting sol solution can be adjusted to between about pH 4 and 10. The process can employ concentrated nitric acid followed by further stirring of the solution for 1 hour. In one embodiment of the invention, the pH of the sol solution is about pH 7 to 10, and more typically about pH 9.

In another embodiment of the invention, the sol solution is on the acidic side, with a pH 4 to 7, and more typically about pH 5.5.

A non-limiting specific example of making an alumina sol solution (sol solution “A”) of the invention was made by adding 62.5 mL (0.5 mole) ethyl acetoacetate (“EtAcAc”) to 1300 mL isopropyl alcohol (“IPA”). After stirring the resulting EtAcAc solution for 10 minutes, 50 mL (0.2 mole) of aluminum tris(sec-butoxide) (“ASB”) was added to the EtAcAc solution, and then the volume of the resulting solution was adjusted to 1400 mL with IPA. After stirring the resulting ASB solution for 2 hours, 3.3 mL of deionized water (diluted by IPA) was added dropwise to the ASB solution, and then the volume of the resulting solution was adjusted to 1.5 L with IPA, having a concentration of aluminum oxyhydroxide of about 0.13 M. After stirring the resulting aluminum oxyhydroxide sol solution for 2 hours, the pH of the resulting solution was adjusted to about pH 9 with concentrated nitric acid followed by further stirring the solution for 1 hour.

In another non-limiting example, an alumina sol solution (sol solution “B”) of the invention was made substantially as above for sol solution “A”, except that the pH of the resulting solution was adjusted to between about pH 6.5 and pH 4.5 with concentrated nitric acid followed by further stirring the solution for 1 hour.

Method 2. Synthetic Method of Aluminum Oxyhydroxide Solution: No Diluting Method.

In general, aluminum alkoxide source materials are very sensitive to moisture or water by which they are decomposed into aluminum oxides or hydroxides. Organic chelating ligands, for example, ethyl acetoacetate cannot be chelated to the decomposed oxides or hydroxides. This can lead to poor purity of the aluminum oxyhydroxide products. We developed several new synthetic methods to improve the purity by synthesizing organic ligand-chelated aluminum complexes without any solvents which may include moisture or water.

The organic ligand-chelated aluminum complexes can be prepared by adding the organic ligand, for example, ethyl acetoacetate (EtAcAc), to the aluminum alkoxide source material, for example, aluminum tris(sec-butoxide) (“ASB”)), in drops without any solvent. Alternatively the organic ligand-chelated aluminum complexes can be prepared by adding the aluminum alkoxide source material to the organic ligand without any solvent. When the two compounds are mixed, the reaction is strongly exothermic, which raises the temperature of the reaction solution. The mixture is gently stirred during the reaction until the mixture is cooling down to room temperature. The resulting solution comprising aluminum complexes (organic ligand-chelated aluminum complexes) is then poured into a solvent, for example, isopropyl alcohol (“IPA”). The volume of the solvent in the resulting procedure can be increased by adding additional solvent for adjusting or improving the homogeneity, solubility or viscosity of the resulting complexes. Once the resulting complexes have been thoroughly stirred (for example, up to 2 hours, or more), a volume of water (deionized) can be added into the resulting complexes to hydrolyze them to aluminum oxyhydroxide sol solution. The pH of the resulting sol solution can be adjusted to between about pH 4 and 10 by employing concentrated nitric acid, followed by further stirring of the solution for 1 hour.

A non-limiting specific example of making an alumina sol solution (sol solution “C”) of the invention was made by adding 62.5 mL (0.5 mole) ethyl acetoacetate (“EtAcAc”) to 50 mL (0.2 mole) of aluminum tris(sec-butoxide) (“ASB”), or by adding 50 mL (0.2 mole) of ASB to 62.5 mL (0.5 mole) EtAcAc. After stirring the resulting mixture until the mixture cools down (about 3 hr) to room temperature, the mixture is poured into 1300 mL IPA, and then the volume of the resulting solution was adjusted to 1400 mL with IPA. After stirring the resulting solution for 2 hours, 3.3 mL of deionized water (diluted by IPA) was added dropwise to the solution, and then the volume of the resulting solution was adjusted to 1.5 L with IPA, having a concentration of aluminum oxyhydroxide of about 0.13 M. After stirring the resulting aluminum oxyhydroxide sol solution for 2 hours, the pH of the resulting solution was adjusted to between about pH 4 and 10 with concentrated nitric acid followed by further stirring the solution for 1 hour.

Optionally, the sol solution can be kept substantially free of water to maintain the aluminum alkoxide in solution, stabilized and solubilized by the organic ligand and the solvent. Once the sol solution has been applied as a coating onto a surface of a substrate, the solution coating can be exposed to moisture or a humid atmosphere to hydrolyze the aluminum alkoxides in situ to aluminum oxyhydroxide.

Purification or filtration of the sol solution, to remove any large polymeric material, is optional. The resulting solution also is very stable without forming any precipitates during coating or storing it for more than 6 months.

Any substrate of any size and shape can be coated with the sol solution. In a typical application, the substrate is a continuous roll of a planar sheet material. In a typically process for preparing a catalyst metal substrate on which CNTs are grown, a stainless steel sheet can be used. Other substrates can include a sheet of a metal or non-metal material, the metal material selected from the group consisting of steel, nickel, zinc, copper, tungsten, tin, titanium, platinum, iron, lead, aluminum and a combination or alloy thereof, and the non-metal material selected from the group consisting of silica, ceramic, glass, quartz, silicon, silicon oxide, indium tin oxide, carbon fiber, graphene, graphite, and their composites or alloys.

A roll of stainless steel, like many metal substrates, has a hydrophobic surface, such that a water-based (aqueous) sol solution may not uniformly coat the surface(s) of the stainless steel. To provide good wetting ability (or a low contact angle) on stainless steels, an alcohol or other polar solvent can be used as the solvent, or included in the sol solution, to reduce the contact angle of the solution, and thus more easily wet the stainless steel. Non-limiting examples of suitable polar solvents include ethanol and isopropyl alcohol (IPA), and a sol solution comprising the polar solvent exhibits good wetting ability and uniform coating on a stainless steel substrate.

In an embodiment of the invention, a stainless steel sheet is continuously unrolled and immersed in a volume of the alumina sol solution and subsequently withdrawn at a constant speed V of at least about 2 cm (1 inch) per minute, and up to about 100 cm (40 inches) per minute; for example, between 4 inches per minute (10 cm/min) and 15 inches per minute (38 cm/min), and including about 8 inches (20 cm/min) to 12 inches per minute (30 cm/min). The resulting alumina sol coating could be uniformly coated on a large stainless steel sheet of 1×100 ft² to produce a controllable, annealed (dried) thickness of the alumina substrate of 10-100 nm, and more typically at least 20 nm, and up to about 70 nm.

In general, the film thickness (T) in a dip-coating processes is given by the equation (I)

T=0.94(γ/ρg)^{1/2}(ηV/γ)^{2/3} (I)

where γ is the surface tension, ρ is the solution density, g is the gravity acceleration, η is the solution viscosity, and V is the withdrawal velocity. As shown by Equation (I), a thicker or thinner coating is expected when either increasing or decreasing, respectively, the withdrawal velocity of the substrates.

It has been determined that when the withdrawal velocity is increased from 4 inches/min to a substantially higher rate, for example, of 20 inches/min, the resulting thicker alumina sol layer (following drying and annealing) peeled off or cracked because of film shrinkage (or high tensile stress), resulting in part from the condensation reaction of hydroxyl groups in the thicker layer. Such catalysts surfaces resulted to poor quality of CNT arrays. On the other hand, when the sol solution and the resulting alumina films are too thin, the CNT arrays cannot grow efficiently, where it is believed that the thin alumina layers cannot sufficiently and effectively keep CNT catalyst metals from diffusing out and through the alumina layer, and into the substrate. Generally, as alumina films became thinner, the CNT array growth was shorter. FIG. 2 shows the results of CNT growth on alumina layers formed by e-beam deposition of alumina.

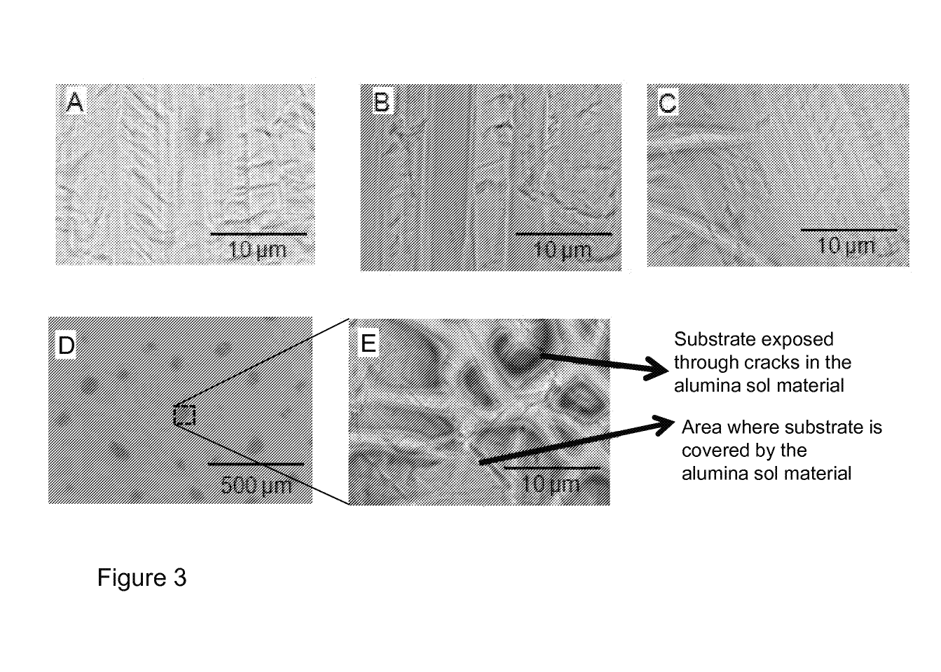

FIG. 3 shows the surface morphology of the alumina sol layers which were coated by varying the withdrawing speed from 2 inches/min, to 4 inches/min, to 6 inches/min, to 8 inches/min, to 12 inches/min, and to 15 inches/min, on stainless steel (SS) sheets. The incidence of minor cracks (Panel 3E) increased as the withdrawing speed increased, and the resulting thickness of an alumina sol layer increased. Minor cracking in the annealed alumina layer may not substantially effect production of commercial quantities of CNT powder. Under conditions of good speed control, a withdrawing speed of about 4 inches/min to about 12 inches/min resulted in good coating uniformity and millimeter-long-grown CNT arrays, with no significant difference in the growth height of the CNT array.

Annealing (drying) of the applied alumina sol coating (aluminum oxyhydroxide layer) is needed to form rigid alumina networks and stable continuous or contiguous alumina films on the substrate. Annealing of the alumina sol layer evaporates and removes residual solvents, organic ligands (e.g., ethylacetoacetate), and water from the alumina sol layer, to form a stable catalytic support layer. It has been shown that the thermal (annealing) treatment properties affect CNT array growth height. The annealing temperature is generally at least about 200° C. and up to about 700° C., and is more typically at least about 300° C. and up to about 650° C., which can including about 400° C. and up to about 600° C., and which can include about 500° C. and up to about 600° C., such as about 550° C. The step of annealing can be performed in an oxidizing atmosphere, selected from the group consisting of air, a mixture of O₂ and Ar, a mixture of O₂ and N₂, and a mixture thereof, at an annealing temperature of at least about 250° C., and up to about 650° C., and more typically of at least about 300° C., and up to about 600° C. Alternatively, the step of annealing can be performed in an inert atmosphere, substantially free of oxygen, at an annealing temperature of at least about 400° C.

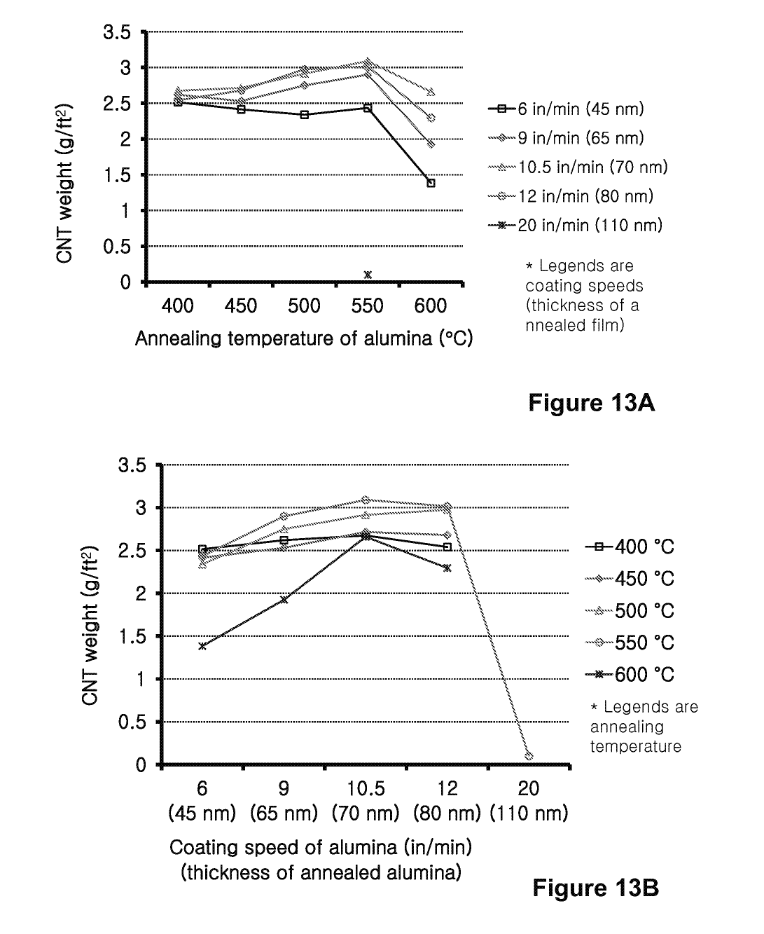

As shown in FIG. 4 and FIGS. 13A and 13B, the CNT array height increases with increasing of the annealing temperature from about 250° C. to about 400° C. for thinner sol solution coatings (for example, as sheet velocity from about 6 inches per minute and toward 9 inches per minute), and from about 450° C. to about 550° C. for thicker sol solution coatings (for example, as sheet velocity between about 9 inches per minute and 10.5 inches per minute, and toward 12 inches per minute). A person of ordinary skill in the art understands that the solution thickness or viscosity and the sheet velocity rate can be optimized for a particular sol solution and processing system. Generally, the CNT arrays grow taller when the sol films are annealed in air, as compared to Ar gas. Annealing the sol films in air is more effective for growing millimeter-long CNT arrays and provides a wider process window. It is believed that the oxygen in air can decompose the EAcAc groups more easily and thereby provide a more hydrophilic alumina surface, compared to an inert atmosphere. When the sol solution layers are annealed in air, the CNT arrays grow tallest at an annealing temperature in the range of 300° C. to 400° C. On the contrary, the CNT arrays grow relatively taller at a temperature of at least 400° C. in Ar gas environment. When the alumina sol layer is annealed in Ar gas at only 300° C., the CNT (Fe) catalysts solution, discussed herein later, did not wet the alumina layer well, and resulted in poor quality CNT arrays. When the sol solution layer was annealed in air, even at 300° C. , good wetting by the CNT (Fe) catalysts solution occurred, while poor wetting ability by the CNT (Fe) catalysts solution has been observed when the sol layer is annealed at a temperature of less than 200° C. in an air environment. The poor wetting ability is believed to result from organic groups, including ethylacetoacetate (EAcAc), that remain bound to the surface of an alumina sol layer. When a sol layer is annealed at such lower temperatures, EAcAc groups are not removed (evaporated, decomposed) completely, and remain on the surface of the sol solution layer, and result in a more hydrophobic surface. The more hydrophobic surface does not subsequently absorb well the CNT catalyst molecules dissolved in hydrophilic polar organic solvents.

The alumina sol layer annealed at higher temperatures may have fewer active sites (Al—OH or Al^{δ+} center) for binding the CNT catalyst molecules in solution, which result from the hydroxyl groups on the annealed sol layer surface condensing to form Al—O—Al networks at such higher temperature. A suitable temperature range for annealing an alumina sol layer in air is from about 300° C. to 600° C.

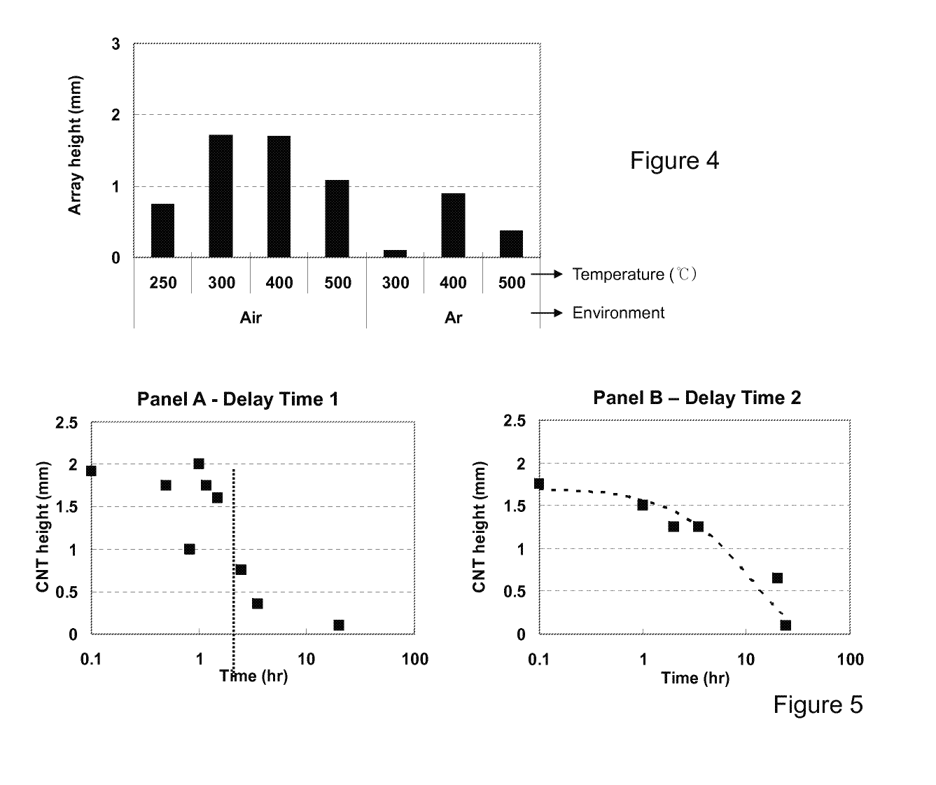

A delay time prior to the step of annealing of the sol solution layer on the substrate can result in changes in the layer that may affect the quality of and growth behavior, including height, of the CNTs. FIG. 5 shows the result of changes in the delay time between the completion of the applying of an alumina sol layer (sol solution “A”), and the annealing of the sol solution coating (Delay Time 1) when stored in air. FIG. 5 also shows the result of changes in the delay time between the annealing of the sol solution, and the subsequent application of the CNT catalyst metal coatings (discussed hereinafter) (Delay Time 2) when stored in air. The CNT growth height appears to be strongly impacted by both Delay Time 1 and Delay Time 2. The array growth height abruptly decreases when the Delay Time 1 is more than about 1 hour, while the growth height gradually decreases with increasing Delay Time 2. The delay time is believed to impact the surface properties by moisture, which may decrease the binding ability of CNT catalyst metal molecules on the alumina sol layer, and results in poor CNT quality. Consequently, the exposure of the alumina sol solution layer to an air environment during Delay Time 1 and Delay Time 2 should be minimized to less than 1 hour, more typically less than 45 minutes, including less than 30 minutes, 20 minutes and 10 minutes. Alternatively, the substrate with the alumina sol layer can be stored within an inert and/or moisture-free environment. In one aspect of the invention, the multiple steps of the process, from application of the alumina sol layers, through annealing of the alumina sol layer, to application of the CNT catalyst metals coating, is performed continuously, in series, and within a relatively short time, preferably well within 1 hour in delay time.

In another aspect of the invention, the alumina sol coating can be dried at a reduced temperature that reduces the levels of solvent, including water, prior to the step of annealing. The drying temperature is typically up to about 100° C., for a time sufficient to harden the alumina sol layer to the touch, prior to annealing.

Following the step of annealing, the alumina-layered substrate becomes useful for depositing and attaching a carbon-nanotube growth catalyst, comprising the base substrate, and the alumina layer comprising aluminum oxyhydroxide molecules, upon the surface of the alumina sol layer.

### B. Depositing CNT Catalyst Metals

The present invention provides a continuous process for coating a solution comprising catalyst metals for growing CNTs, the solution comprising catalyst metal ions bound to an organic ligand. The process results in a stabilized catalyst metal substrate that grows vertically aligned, high quality CNT arrays. The process is suitable for depositing and stabilizing catalyst metal, for growing CNTs, on either or both sides of a flat or planar substrate, or on non-flat substrates, including beads and other particulate substrates, by covering the surface of the substrate with the alumina sol layer, followed by the catalyst metals.

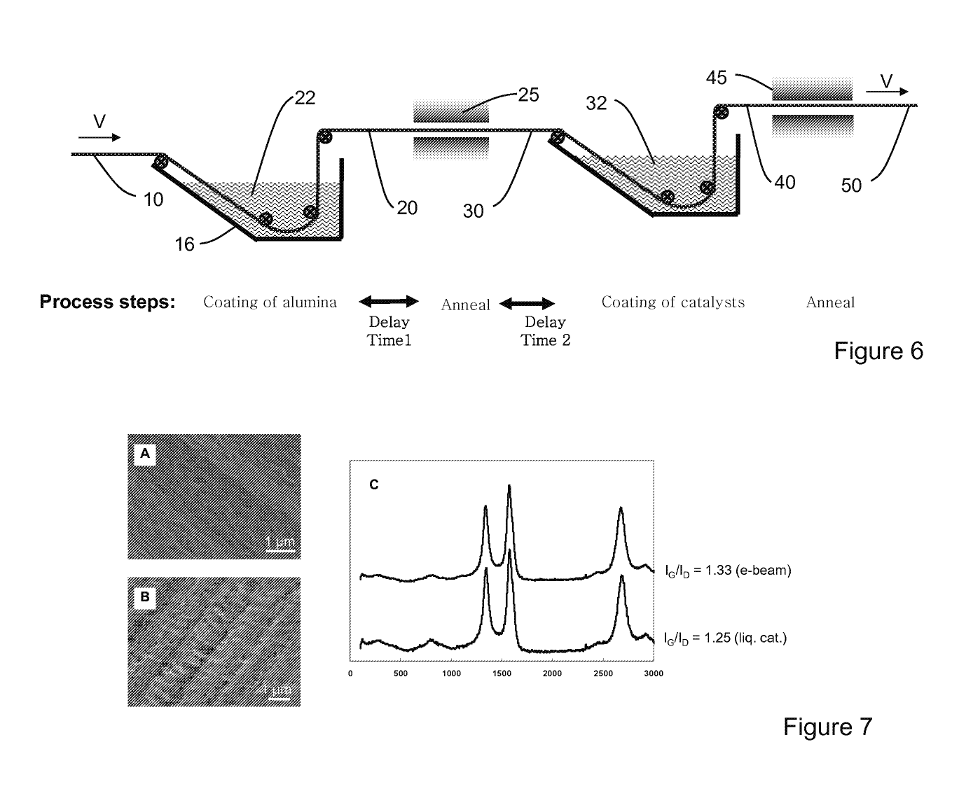

FIG. 6 shows a schematic diagram of the process system and steps for depositing an alumina sol coating onto a sheet substrate, annealing the alumina sol layer, depositing a catalyst metal solution layer onto the annealed alumina sol substrate, and annealing the catalyst metal layer to form a metal catalyst growth substrate. The sheet substrate 10 is immersed into and withdrawn out of the alumina sol solution 22, to provide an alumina sol-coated sheet substrate 20, which is then dried and annealed in an oven or furnace 25 to form an annealed alumina sol substrate 30, substantially as shown in FIG. 1. The annealed alumina sol substrate 30 is immersed into and withdrawn out of the catalyst metal solution 32, to provide a catalyst metal-coated sheet substrate 40, which is then dried and annealed in an oven or furnace 45 to form a stabilized catalyst metal substrate 50. The stabilized catalyst metal substrate 50 can be rolled up onto a take-up roller (not shown) for storage and later use as the catalyst substrate for CNT growth, or can be processed continuously and in series with a CNT growth reactor.

A catalyst metal suitable for growth of CNTs is applied to and stabilized upon the alumina sol substrate, described above, by a wet chemical process. Metal ions can be coated onto the annealed alumina sol layer by any one of a variety of coating methods, including spraying and dip-coating. A suitable catalyst metal for growing CNTs can be selected from iron, cobalt, and nickel, and combinations and alloys thereof. A combination of iron (Fe) with either or both cobalt and nickel can have a molar ratio (Fe:other metal) of at least 1:10, and up to about 10:1, and can include 1:5, 1:3, 1:2, 1:1, 2:1, 3:2 and 5:1. Under conventional conditions, metal ions in a coated solution form aggregates during the coating or the drying stage, typically producing non-uniform CNT arrays or patch-like bundles, rather than an effective level of uniformly distributed catalyst particles. The present invention provides forming CNT catalyst metal complexes in which a catalyst metal ion is chemically bound to an organic ligand, and deposited and stabilized onto the annealed alumina sol layer comprising the aluminum oxyhydroxide with good distribution. Subsequent processing of the stabilized catalyst metals under CNT growth conditions results in the uniform grow of CNT arrays. The organic ligand is believed to promote separation of the catalyst metal ions from one another by reducing ionic interaction therebetween, which in turn minimizes the formation of aggregates and produces a suitable-sized (nano-sized) catalyst particles for the effective growth of CNTs.

Suitable CNT catalyst metals can be deposited onto the alumina sol layer that comprises the alumina oxyhydroxide in the layer surface, by the appropriate selection of parameters, including the species of one or more carboxylic acids, the concentration of CNT catalyst metal solution, the ratio of catalyst components, the concentration of constituents of the CNT catalyst metal solution, and the substrate withdrawing speed.

In an embodiment of the invention, the CNT catalyst metal solution comprises a mixture of Fe(NO₃)₃, Gd(NO₃)₃, and carboxylic acids such as 2-methylpentanoic acid (PEN) and 2-ethylhexanoic acid (HEX). In general, Fe³⁺ and Gd³⁺ ions can form 6-coordinate complexes, and the carboxylic acid binds to a metal center as a bidentate ligand. Each metal center can be predicted to react with 3 equivalents of carboxylic acids. As mentioned above, the alumina sol layers have the limited hydroxide active sites to attract and bind to the CNT catalyst metal molecules. It is believed that all molecules in a CNT catalyst metal solution, including the catalyst metal and the carboxylic acids, compete with one another for binding at the active hydroxide sites. It is predicted that the carboxylic acids react with hydroxyl groups on the surface of the alumina sol layer, and that when the proper molar proportion of carboxylic acids (3 equivalents of carboxylic acids), effective binding and stabilizing of the CNT catalyst metals results in effective CNT growth (typically millimeter-long CNTs). On the other hand, when an excess of carboxylic acids is contained in the catalyst metal solution, they effectively compete for and occupy a substantial number of the active sites, which inhibits binding of CNT catalyst metal molecules to the active sites. For example, when 12 equivalents of carboxylic acids (that is, as excess of 2-methylpentanoic acid), the result was the production of very short (100 μm) arrays of CNTs.

The CNT catalyst metal solution comprising the carboxylic acids promotes an acidic media (low pH) that separates the CNT catalyst metal molecules from one another, minimizing formation of aggregates during coating and drying steps, and stabilizes the CNT catalyst metals. It is known that alkaline media (high pH) can decompose the metal ions (Fe and Gd) into Fe₂O₃ and Gd(OH)₃ precipitates and aggregates, resulting in the poor grown CNT arrays in bunches and with very low height.

The catalyst metals solution also comprises a solvent for assisting in the wetting of the annealed alumina sol layer, and for dissolving and dispersing the catalyst metal ions. A suitable solvent is isopropyl alcohol (IPA). The catalyst metal ions are suitably provided in a soluble or dissolvable salt form. A suitable salt form is a metal nitrate, which has good solubility in IPA to promote efficient binding of the organic ligands with the catalyst metal ions.

A non-limiting example is provided of a CNT catalyst metal solution (catalyst metal solution “B”) comprising a mixture of iron nitrate and gadolinium nitrate as a binary catalyst for growing CNT arrays. The CNT catalyst metal solution is prepared by the following steps: 1) Iron nitrate nonahydrate (Fe(NO₃)₃.9H₂O) of 9.09 g (15 mmol) and gadolinium nitrate hydrate (Gd(NO₃)₃.6H₂O) of 2.54 g (3.75 mmol) were added to 1.3 L of IPA with stirring. 2) Three (3) equivalents of 2-methylpentanoic acid (7 mL, 56.25 mmol) were added to the stirring IPA solution, and the volume of the resulting solution was adjusted to 1.5 L with IPA. 3) After stirring for 1 hour, the resulting solution was used to coat CNT catalyst on the annealed alumina sol films.

A suitable substrate, comprising a layer of alumina sol comprising oxyhydroxide molecules on the surface, is coated with the catalyst metal solution. In a suitable process, the catalyst metal solution is coated in a layer on a sheet substrate by dip processing. The substrate having annealed alumina sod layer is immersed into and subsequently withdrawn from the catalyst metal solution, continuously and preferably at a constant, suitable speed. The resulting catalyst metal solution layer uniformly coats the annealed alumina sol layer of the substrate. The as-coated catalyst metal layer includes the nitrate anion, the carboxylic acid, the catalyst metal ion, and residual solvent IPA. An example of a suitable catalyst metal concentration in the catalyst metal solution for growing CNT arrays is from about 10 mM to about 20 mM, including 15 mM. An example of a suitable substrate withdrawing speed can be from about 4 inches/min to 12 inches/min. A catalyst metal layer formed at both 15 mM and 10.5 inches/min provided an optimal size of catalyst particles for growing long, denser vertically-aligned CNTs.

Once the catalyst metal ion is bound to the hydroxide sites of the alumina sol layer, the remaining components—the nitrate anion, the carboxylic acid, and residual solvent IPA—are removed by decomposition and evaporation, typically by drying and annealing the resulting substrate. The organic ligand and solvent (IPA) are relatively volatile, and evaporate. The nitrate ions on the other hand are decomposed in air at higher temperatures of about 200° C. or more, with turning the metal (Fe) nitrates into metal (Fe) oxides. A suitable temperature for annealing the catalyst metal-coated substrate is at or above 300° C., more suitably at, about or above 400° C. in air, more suitably at, about or above 500° C., and more suitably at, about or above 550° C. in air, resulting in nanometer-sized metal oxides. Annealing of the catalyst metal coating, which typically occurs in an air environment, oxidizes the catalyst metal complexes (such as Fe(NO₃)₃.xH₂O, Ni(NO₃)₂.xH₂O and Co(NO₃)₂.xH₂O) to the metal oxides (FeₓO_{y}, NiₓO_{y} and CoₓO_{y}).

It can be understood that when processing a continuous roll of sheet substrate, the selection of processing conditions and the concentrations and properties of the alumina sol and catalyst metal solutions, will results in the use of withdrawing speeds that are optional for both wet processes.

The resulting CNT catalyst metal substrate is then processed under CNT growth conditions to grow CNT arrays, described herein later.

### C. Hydrating of the Metal-Catalyst

In a further aspect of the invention, following its annealing, the catalyst metal alumina-supported substrate can optionally be hydrated with an amount of water and for a time sufficient to effect improved CNT growth, in terms of CNT height, growth weight, and/or growth height, in the resulting hydrated CNT catalyst metal substrate.

One efficient and convenient method for hydrating includes immersing the catalyst metal substrate into an aqueous solution for a time sufficient, which is typically at least a few minutes, including about 5 minutes, or more. The temperature of the aqueous solution can be room temperature. The immersion time in and the temperature of the aqueous solution can be adjusted to achieve the improved growth of the CNTs.

Alternative means for hydrating the CNT catalyst metal substrate can include steam baking, microwave-assisted heating, spraying, roll coating, curtain coating, slot coating, slide coating, and spin coating, and a roll-to-roll process.

The excess water in the hydrated catalyst metal-coated sheet substrate can be dried at a reduced temperature to remove most of the free water, prior to a step of annealing at a temperature of about or above 150° C., for a time sufficient to improve CNT growth, typically for about 5 minutes.

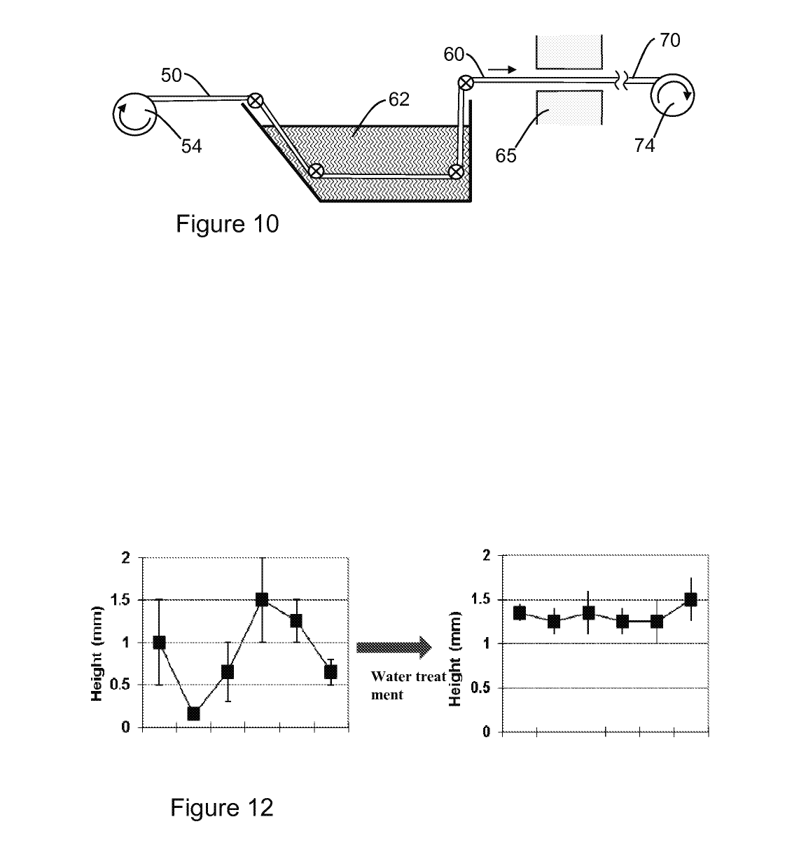

FIG. 10 shows a schematic diagram of the process system and steps for hydrating the CNT catalyst metal substrate. The annealed CNT catalyst metal substrate 50 is unwound from a roll 54 and is immersed into and withdrawn out of a water solution 62, to provide a hydrated catalyst metal-coated sheet substrate 60, which is then dried and annealed in an oven or furnace 65, and taken up on a roll 74 to form a second stabilized catalyst metal substrate 70. The second stabilized catalyst metal substrate 70 can be collected onto a take-up roller (not shown) for storage and later use as the catalyst substrate for CNT growth, or can be processed continuously and in series through a CNT growth reactor, generally producing taller CNTs.

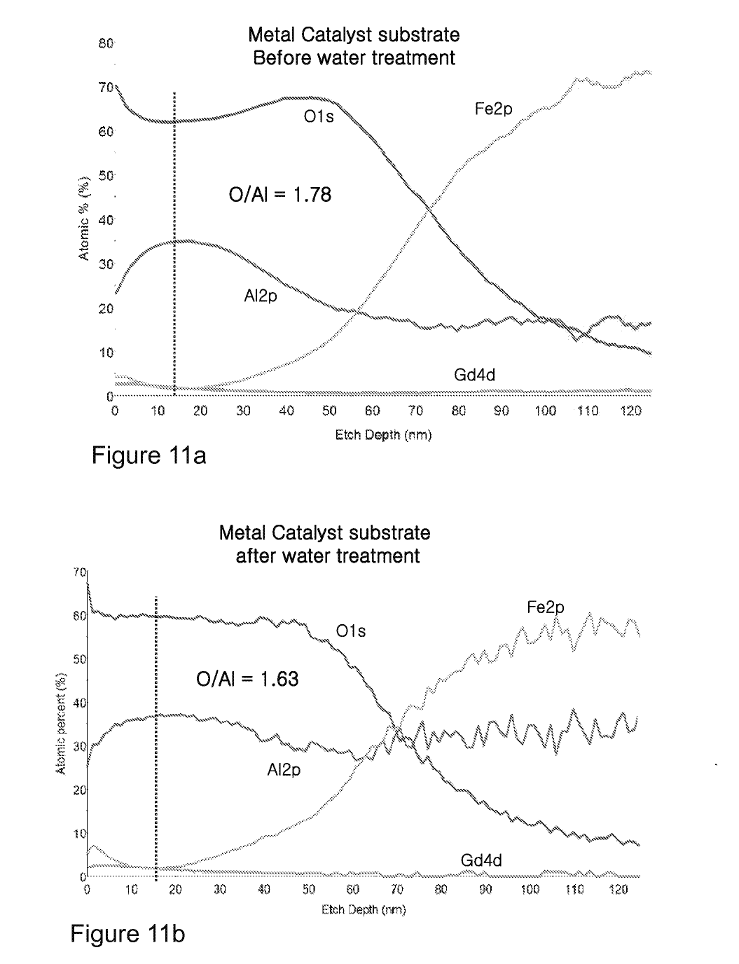

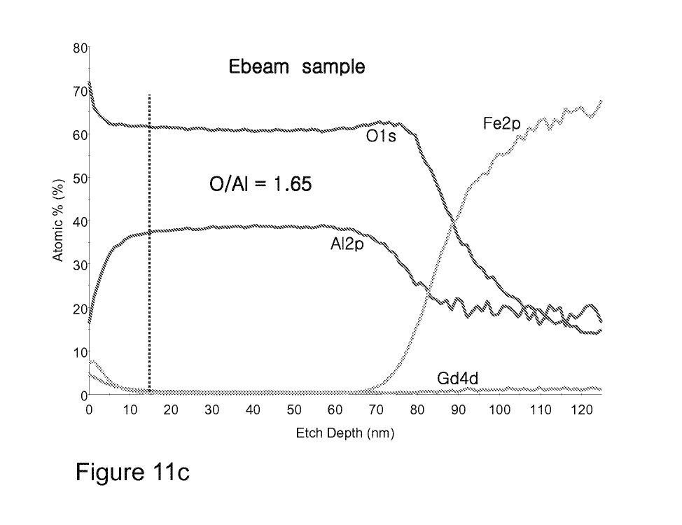

Without being bound by any particular theory, it is believed that the water causes the surface of the alumina layer to become denser and compact, and may form more Al—O networks. The water may also dissolve away uncured portions of the alumina surface. FIG. 11 shows X-ray photoelectron spectroscopy (XPS) results showing that the water washing of the (unwashed) CNT catalyst metal substrate (FIG. 11a) results in removal of hydroxyl groups from the alumina layer, which shifts the ratio O/Al in the resulting (cured) stabilized catalyst metal substrate (FIG. 11b) to that of conventional electron beam deposition of alumina substrates (FIG. 11c) according to the prior art.

FIG. 12 illustrates the improvement of a water immersion on the consistency of CNT growth for a series of similarly-made metal catalysts substrate samples, showing the variability of the CNT growth before water immersion, and the improvement in consistency of CNT growth afterward.

### D. CNT Catalyst Metal Stabilization on Non-Planar and Bead-Like Substrates

It is well known that fluidized-bed processes are cost-effective and very productive for continuously producing CNT powder. Small sized beads, including those used as a fluidizing bed media, can provide a larger area, per unit mass or unit volume, than does a flat, planar substrate. Short CNTs having a length of less than 100 μm have been produced dominantly in fluidized-bed processes using floating catalysts such as ferrocene.

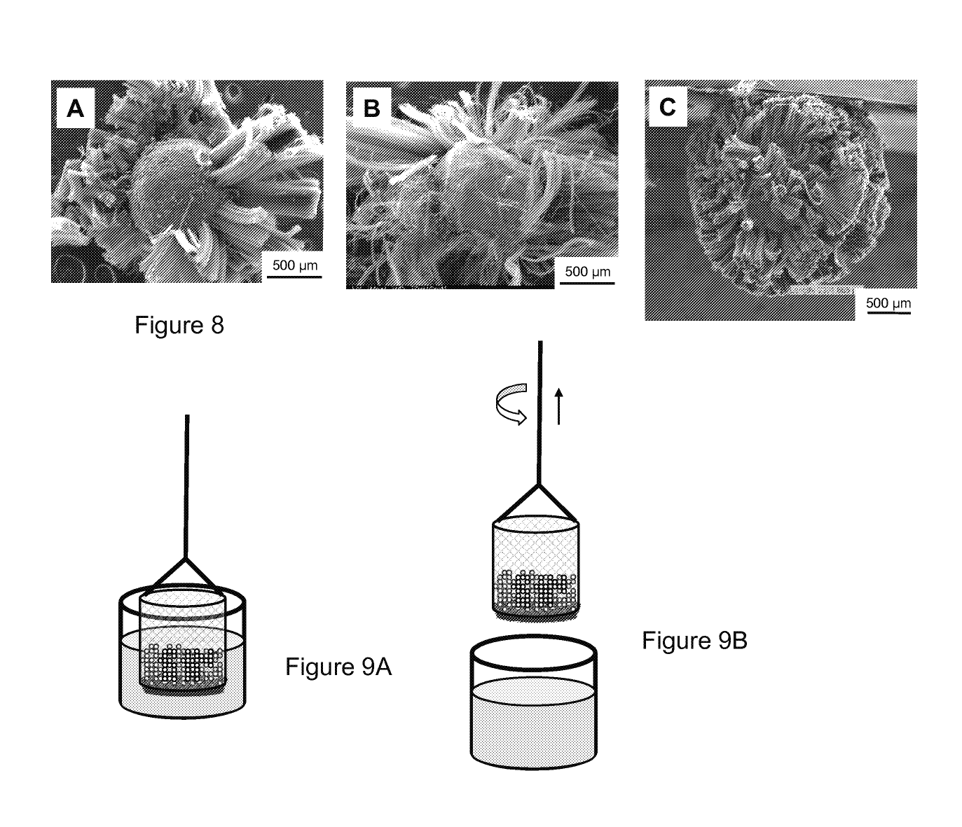

The present invention also provides for particulate and other non-planar (three dimensional or 3-D) substrates on which a stabilized catalyst metal is formed in accordance with the processes and methods described herein before. Such particulate and other non-planar substrates are processed under CNT growth conditions to form millimeter-long CNTs. Examples of non-planar substrates included a bead or plurality of beads made of a material that can includes ceramic, alumina, and stainless steel. The conditions used for forming a substrate having an alumina sol layer comprising oxyhydroxide molecules, or for forming the stabilized catalyst metals, are substantially as described herein above. The method(s) or means for immersing and withdrawing the substrate in the alumina sol solution and catalyst metal solutions, respectively, can include the dispersing of beads, for example, in an alumina sol solution or a CNT catalyst metal solution, filtering the same on a porous tray, and then annealed the filtered substrate in air at 400° C. Following processing in CNT growth conditions, sub-millimeter-long CNTs grew fully on the surface of each bead. FIG. 8A shows 200-800 micron-length CNTs grown on the surface of an alumina bead. FIG. 8B shows 800 micron-length CNTs grown on the surface of a stainless steel bead. FIG. 8C shows 600 micron-length CNTs grown on the surface of a ceramic bead.

Any number of methods can be used for withdrawing the plurality of particulate or non-planar substrates from the solutions, and in particular the alumina sol solution to promote uniform sol layer thickness and annealed alumina sol layer. One example is illustrated, where in FIG. 9A a plurality of beads are placed into a net container and immersed within an alumina sol solution. As shown in FIG. 9B, the alumina sol-coated beads are drawn up out of the sol solution, and the net container rotated to improve removal of the excess sol solution from the surfaces of the bead substrates. Other methods of applying and drying (stabilizing) a coating solution onto a particle substrate include fluidized bed processes, spray coating and drying, roll coating, and slot die coating. The sol solution can be sprayed or streamed onto the substrate particles, or the substrate particles immersed into the sol solution, and any excess sol solution drained or drawn away as needed, and the surfaces dried using a drying air stream or furnace, to form the coated particles.

### E. CNT Array Growth

Following the annealing of the catalyst metal layer, the catalyst metal laden substrate is ready for CNT growth. The catalyst metal substrate has formed on its surfaces the catalyst metal-oxide of the catalyst metal and the aluminum oxyhydroxide of the annealed alumina support layer.

The CNTs formed can include single-wall nanotubes (SWNTs), double-wall nanotubes (DWNTs), and multi-wall nanotubes (MWNTs).

In a first step, the catalyst metal-oxide is reduced to form the catalyst metal particles or “nanoclusters”, which form the catalyst growth sites for the CNTS. The reduction step typically comprises heating of the catalyst metal substrate to about 780° C. (including a temperature up to about 780° C.) in an atmosphere of hydrogen gas. For example, an argon flow can be initiated at about 25° C., followed by hydrogen flow at about 100° C. to reduce the oxide of the catalyst metal oxide (such as FeₓO_{y}, NiₓO_{y} and CoₓO_{y}) to the elemental metal (Fe, Ni and Co).

Carbon nanotubes (CNTs) can be grown by what is commonly referred to as oriented synthesis, where the carbon nanotubes are aligned and grown in the form of an array on the substrate. The array contains many carbon nanotubes grown in a direction substantially perpendicular to portion of the surface on which the catalyst particle is disposed. Where the catalyst particles are arranged in a single planar surface of a substrate, the CNTs will grow in one direction. Carbon nanotubes (CNTs) can also be grown by what is commonly referred to as bulk synthesis, where the carbon nanotubes are grown on the outer surfaces of particulate or non-planar substrate. Particulate and non-planar substrates have curved and angled surfaces such that the CNTs grow in a wide variety of directions, though typically perpendicularly to the surface on which the nano-sized catalyst metal particle resides.

The resulting substrate including the stabilized CNT catalyst metal layer is processed under CNT growth conditions to form CNT arrays. The quality and growth rate of the CNT arrays (grown using catalyst metal solution “B”) is comparable to those of CNT arrays grown by a conventional e-beam process in both CNT alignment and quality (I_{D}/I_{G} ratio), as illustrated in FIG. 7. An example of the CNT growth conditions is disclosed in US Application Publication 2008/0095695 (Shanov et al), the disclosure of which is incorporated by reference in its entirety. The wet chemical process of the present invention enables production of CNT arrays continuously in high volume and over a large surface area. CNTs can be grown under CNT growth conditions in a continuous roll catalyst substrate as described in US Patent Publications 2012-0058352 (Shah et al) and 2011-0230373 (Beijing Funate), and U.S. Pat. No. 7,504,078 (Jacques et al), the disclosures of which are incorporated by reference in their entireties.

A non-limiting example of the growth of a CNT array by thermal chemical vapor deposition utilizes a gas mixture of hydrogen, a carbon source, an inert gas, and water. Most conventional CNT growth reactors are suitable for growing CNTs, including an EasyTube Furnace (First Nano, Inc.). The carbon source can be any of a variety of commonly-used carbonaceous gases, including ethylene, acetylene, methane, methanol, ethanol and carbon monoxide. The inert gas can include argon. In a non-limiting example, a mixture of hydrogen, acetylene, water, and argon is applied at a temperature of 700° C. to 800° C., preferably at about 780° C. The water may be supplied by flowing argon through a water bubbler operating at room temperature. The gas flow is introduced into the reactor for a period of time sufficient to grow the CNTs to the desired or target length, or until CNT growth terminates.

The mixture of the gases flowing into the CNT growth reactor can be varied. For example, the volumetric ratio of argon flowing through a water bubbler to the main argon flow going through the reactor may be between 0.05 and 0.3, the volumetric ratio of acetylene to argon may be between 0.01 and 0.05, the volumetric ratio of acetylene to hydrogen may be between 0.1 and 1, and the volumetric ratio of the hydrogen to argon may be between 0.05 to 0.3. Other growth conditions and resulting CNT features are described in US Application Publication 2008/0095695, supra.

Accordingly, it will be apparent to those of ordinary skill in the art that many more embodiments and implementations are possible that are within the scope of the claims. Therefore, the embodiments described are only provided to aid in understanding the claims and do not limit the scope of the claims.

1. A process for applying an alumina catalyst support layer onto a substrate, comprising the steps of:
a) applying a coating of an alumina solution comprising aluminum oxyhydroxide and a solvent onto a substrate, and
b) annealing the coating of the alumina solution on the substrate, to remove the solvent, and to form an alumina catalyst support layer comprising aluminum oxyhydroxide.

2. The process according to claim 1, wherein the alumina solution comprises at least about 0.05 M, and up to about 0.3 M, by concentration, the aluminum oxyhydroxide.

3. The process according to claim 1, wherein the alumina solution has a pH from about pH 8 to 11.

4. The process according to claim 1, wherein the alumina solution further comprises an organic ligand selected from the group consisting of C1-C6 acetoacetate, acetylacetone, and mixtures thereof; preferably, ethyl acetoacetate.

5. The process according to claim 1 for further applying a catalyst on the alumina catalyst support layer of the substrate, comprising the further steps of:
c) applying a coating of a catalyst metal solution comprising a catalyst metal and a metal ligand, onto the annealed alumina support layer of the substrate; and
d) annealing the coating of the catalyst metal solution on the annealed alumina catalyst support layer of the substrate, to form a catalyst metal oxide with the aluminum oxyhydroxide of the annealed alumina support layer.

6. The process according to claim 5, wherein the catalyst metal is selected from the group consisting of iron (Fe), cobalt (Co) and nickel (Ni); preferably Fe.

7. The process according to claim 6, wherein the catalyst metal solution further comprises an auxiliary compound, selected from the group consisting of a lanthanide, an actinide, Sc, Y and Al; where the lanthanide comprises a lanthanide metal is selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

8. The process according to claim 5, wherein catalyst metal solution is a solution made by combining a metal compound selected from the group consisting of MmXn and MmOlXn, the metal ligand, and a polar solvent, wherein M is selected from the group consisting of Fe, Ni and Co, and mixtures thereof, X is selected from the group consisting of nitrate, sulfate, halide, alkyl acetoacetate, acetylacetone, or RO, m is about 1 to about 3, l is about 1 to about 3, and n is about 1 to about 9, and R is C1-C6 alkyl or C1-C6 acyl.

9. The process according to claim 8, wherein the solution is made by further combining an auxiliary compound, the auxiliary compound selected from the group consisting of M′X′n, M′mO′lX′n, and mixtures thereof, wherein M is selected from the group consisting of a lanthanide, an actinide, Sc, Y and Al, and mixtures thereof, X is selected from the group consisting of nitrate, sulfate, halide, alkyl acetoacetate, acetylacetone, or RO, m is about 1 to about 3, l is about 1 to about 3, and n is about 1 to about 9, R is C1-C6 alkyl or C1-C6 acyl.

10. The process according to claim 5, wherein the catalyst metal solution comprises catalyst metal at a concentration of about 10 mM to about 20 mM.

11. The process according to claim 8, wherein the metal compound comprises iron nitrate.

12. The process according to claim 10, wherein the auxiliary compound comprises gadolinium nitrate.

13. The process according to claim 5, wherein the metal ligand is selected from the group consisting of R—CO2H, alkyl acetoacetate, acetylacetone, ethylenediaminetetraacetic acid (EDTA) and salts thereof, ethylenediaminediaceticacid (EDDA) and salts thereof, trans-1,2-diamino-cyclohexan-N,N,N′,N′-tetraacetic acid (CDTA) and salts thereof, ethyleneglycol-O,O′-bis-(2-aminoethyl)-N,N,N′, N′-tetraaceticacid (EGTA) and salts thereof, diethylenetriamine-pentaacetic acid (DTPA) and salts thereof, N-(2-hydroxyethyl)-ethylenediamine-N,N′,N′-triaceticacid (HEDTA) and salts thereof, nitrilotriaceticacid (NTA) and salts thereof, triethylentetramine-N,N,N′,N″,N′″,N″″-hexaaceticacid (TTHA) and salts thereof, polypyridyl ligands including terpyridine, 2,2′-bypyridine, and 1,10-phenathroline, beta-diketone (acetylacetonate) ligands, such as 2,4-propanedione and derivatives thereof, catecholate and aryloxide or alkyloxide ligands, macrocyclic ligands such as cyclam, cyclen, triazacyclononane and derivatives thereof, and a combination thereof, wherein R— is a linear or branched alkyl group having 1 to 10 carbon atoms; preferably, R—CO2H, alkyl acetoacetate, acetylacetone, and combinations thereof.

14. The process according to claim 13, wherein the carboxylic acid comprises a branched-chain C6-C8 carboxylic acid.

15. The process according to claim 5, wherein the catalyst metal solution further comprises a polar solvent selected from the group consisting of C1-C8 linear or branched alkanols, DMF, DMSO, acetone, propylene carbonate, tetrahydrofuran, acetonitrile, acetic acids and mixtures thereof.

16. The process according to claim 5, wherein the dried coating is maintained in the atmosphere, prior to applying the coating of the catalyst metal solution, for not more than 24 hours.

17. The process according to claim 5, wherein in the step of annealing the coating of the catalyst metal solution, the annealing temperature is more than about 200° C. and up to about 700° C.

18. The process according to claim 5, wherein the step of annealing the coating of the catalyst metal solution is in an atmosphere selected from the group consisting of air, a mixture of O₂ and Ar; a mixture of O₂ and N₂, and a mixture thereof.

19.-23. (canceled)

24. The process according to claim 5, wherein the step of applying comprises immersing the substrate having the alumina catalyst support layer in a volume of the catalyst metal solution, and withdrawing the substrate from the catalyst metal solution.

25. The process according to claim 24, wherein the substrate is a continuous sheet of a substrate material, and the continuous sheet is withdrawn from the catalyst metal solution at a rate of at least about 0.5 inch/min, and up to about 20 inches/min.

26.-29. (canceled)

30. The process according to claim 29, wherein the substrate is a sheet of stainless steel.

31. The process according to claim 1, wherein the solvent comprises a polar solvent selected from the group consisting of C1-C8 alkanols, dimethylformamide, DMSO, and mixtures thereof, and preferably isopropyl alcohol (IPA).

32. The process according to claim 1, wherein the step of applying comprises immersing the substrate in a volume of the alumina solution, and withdrawing the substrate from the alumina solution.

33.-39. (canceled)

40. The process according to claim 1, wherein the alumina solution is a solution made by combining aluminum (C2-C6) alkoxide, an organic ligand, and a polar solvent; more typically aluminum tris (sec-butoxide), ethyl acetoacetate, and isopropanol.

41.-60. (canceled)
